(19) United States
(12) Patent Application Publication
(10) Pub. No.: US 2019/0193751 A1
(43) Pub. Date: Jun. 27, 2019

(54) VEHICLE-MOUNTED INTERFACE DEVICE, DETERMINATION METHOD, AND STORAGE MEDIUM

(71) Applicant: Panasonic Intellectual Property Management Co., Ltd., Osaka (JP)

(72) Inventors: JEFFRY FERNANDO, Osaka (JP); HIDETO MOTOMURA, Kyoto (JP); SAHIM KOURKOUSS, Osaka (JP); KOICHI EMURA, Kanagawa (JP); ERIKO OHDACHI, Kanagawa (JP)

(21) Appl. No.: 16/286,230

(22) Filed: Feb. 26, 2019

Related U.S. Application Data
(63) Continuation of application No. PCT/JP2017/034415, filed on Sep. 25, 2017.

(30) Foreign Application Priority Data
Sep. 27, 2016 (JP) 2016-188581

(51) Int. Cl. B60W 50/10; G01C 21/36; G01C 21/34; G08G 1/0968

(52) U.S. Cl. CPC B60W 50/10; G01C 21/3617; G05D 1/021; G01C 21/3484; G08G 1/096888; G01C 21/3641

(57) ABSTRACT

A vehicle-mounted interface device includes a receiver and a determiner. The receiver receives an input from a driver who drives a vehicle. On the basis of the input received by the receiver, the determiner determines whether or not the driver is familiar with a route along which the driver is to drive or is driving the vehicle.

### CROSS-REFERENCE TO RELATED APPLICATIONS

This application is a continuation of the PCT International Application No. PCT/JP2017/034415 filed on Sep. 25, 2017, which claims the benefit of foreign priority of Japanese patent application No. 2016-188581 filed on Sep. 27, 2016, the contents all of which are incorporated herein by reference.

### BACKGROUND

### 1. Technical Field

The present disclosure relates to a vehicle-mounted interface device, a determination method, and a storage medium.

### 2. Description of the Related Art

Vehicle-mounted interface devices, such as car navigation devices, are known to include technology for supporting a driver for driving operations. For example, Japanese Patent Unexamined Publication No. 2009-264880 discloses creation of a driver model based on travel data corresponding to biological data indicating the state of tension.

### SUMMARY

In the above vehicle-mounted interface devices, more effective service may be provided by determining whether or not a driver is familiar with a route along which the driver is to drive or is driving a vehicle, and implementing the operations according to a determination result.

Accordingly, an object of the present disclosure is to offer a vehicle-mounted interface device and a determination method that can determine whether or not the driver is familiar with a route along which the driver is to drive or is driving the vehicle.

An aspect of the vehicle-mounted interface device of the present disclosure includes a receiver and a determiner. The receiver receives an input from a driver who drives a vehicle. Based on the input received by the receiver, the determiner determines whether or not the driver is familiar with a route along which the driver is to drive or is driving the vehicle.

The present disclosure can thus offer the vehicle-mounted interface device and the determination method that can determine whether or not the driver is familiar with a route along which the driver is to drive or is driving the vehicle.

### BRIEF DESCRIPTION OF DRAWINGS

FIG. 1 illustrates an example of use of a vehicle-mounted interface device in accordance with a first exemplary embodiment.

FIG. 2 is a block diagram of the vehicle-mounted interface device in accordance with the first exemplary embodiment.

FIG. 3 is a flow chart illustrating an operation of the vehicle-mounted interface device in accordance with the first exemplary embodiment.

FIG. 4 is a flow chart of a determination process by the vehicle-mounted interface device in accordance with the first exemplary embodiment.

FIG. 5 is a block diagram of a vehicle-mounted interface device in accordance with a second exemplary embodiment.

FIG. 6 is a flow chart of a determination process by the vehicle-mounted interface device in accordance with the second exemplary embodiment.

FIG. 7 illustrates intervention in accordance with the second exemplary embodiment.

FIG. 8 is a block diagram of a vehicle-mounted interface device in accordance with a third exemplary embodiment.

FIG. 9 is a flow chart illustrating an operation of the vehicle-mounted interface device in accordance with the third exemplary embodiment.

FIG. 10 is a flow chart of a determination process by the vehicle-mounted interface device in accordance with the third exemplary embodiment.

FIG. 11 is a flow chart of a determination process by a vehicle-mounted interface device in accordance with a modified example of the third exemplary embodiment.

FIG. 12 illustrates an example of a travel history in accordance with the modified example of the third exemplary embodiment.

FIG. 13 is a block diagram of a vehicle-mounted interface device in accordance with a fourth exemplary embodiment.

FIG. 14 is a flow chart illustrating an operation of the vehicle-mounted interface device in accordance with the fourth exemplary embodiment.

FIG. 15 is a flow chart of a learning process in accordance with the fourth exemplary embodiment.

FIG. 16 is a flow chart of a driving support process in accordance with the fourth exemplary embodiment.

FIG. 17 is a flow chart of a control process based on a determination result in accordance with the fourth exemplary embodiment.

FIG. 18 is a flow chart of a driving support process in accordance with computing resources allocated to driving prediction in accordance with the fourth exemplary embodiment.

FIG. 19 is a flow chart of a control process based on a determination result in accordance with a fifth exemplary embodiment.

### DETAILED DESCRIPTION OF PREFERRED EMBODIMENTS

A vehicle-mounted interface device in an aspect of the present disclosure includes a receiver and a determiner. The receiver receives an input from a driver who drives a vehicle. Based on the input received by the receiver, the determiner determines whether or not the driver is familiar with a route along which the driver is to drive or is driving the vehicle.

This vehicle-mounted interface device can thus appropriately determine whether or not the driver is familiar with the route along which the driver is to drive or is driving the vehicle.

For example, when the driver sets (inputs) a destination to the receiver, the determiner determines that the driver is unfamiliar with the route along which the driver is to drive the vehicle. When the driver does not set a destination to the receiver, the determiner may determine that the driver is familiar with the route along which the driver is to drive the vehicle.

Accordingly, based on whether or not a destination is set, the vehicle-mounted interface device can appropriately determine whether or not the driver is familiar with the route along which the driver is to drive the vehicle.

For example, the vehicle-mounted interface device may further include a travel history database that stores a travel history. The determiner may determine that the driver is unfamiliar with the route along which the driver is to drive the vehicle when the driver sets a destination to the receiver and the set destination is not included in the travel history.

Accordingly, this vehicle-mounted interface device can appropriately determine whether or not the driver is familiar with the route along which the driver is to drive the vehicle according to the travel history.

For example, the determiner may determine that the driver is familiar with the route along which the driver is to drive the vehicle when a destination is set to the receiver by the driver and the set destination is included in the travel history.

Accordingly, the vehicle-mounted interface device can appropriately determine whether or not the driver is familiar with the route along which the driver is to drive the vehicle according to the travel history.

For example, the travel history may include a travel number of times to each destination. In this case, the determiner may determine that the driver is unfamiliar with the route along which the driver is to drive the vehicle when a destination is set to the receiver by the driver, the set destination is included in the travel history, and the travel number of times to the destination is less than a first predetermined threshold. On the other hand, the determiner may determine that the driver is familiar with the route along which the driver is to drive the vehicle when the destination is set to the receiver by the driver, the set destination is included in the travel history, and the travel number of times to the destination is equal to or greater than the first predetermined threshold.

Accordingly, the vehicle-mounted interface device can appropriately determine whether or not the driver is familiar with the route along which the driver is to drive the vehicle according to the travel number of times.

For example, the determiner may determine that the driver is unfamiliar with the route along which the driver is driving the vehicle when an input number of times to the receiver by the driver while driving is equal to or greater than a second predetermined threshold, and determine that the driver is familiar with the route along which the driver is driving the vehicle when the input number of times is less than the second predetermined threshold.

Accordingly, the vehicle-mounted interface device can appropriately determine whether or not the driver is familiar with the route along which the driver is driving the vehicle according to the input number of times during traveling.

For example, the vehicle-mounted interface device may further include a driving supporter that provides a driving support for at least partially automated vehicle driving. The above input number of times may be a number of times of input by the driver for changing an option of the driving support while driving.

Accordingly, the vehicle-mounted interface device can appropriately determine whether or not the driver is familiar with the route along which the driver is driving the vehicle according to a number of times of changing the option of the driving support.

For example, the vehicle-mounted interface device may further include a driving supporter that provides a driving support for at least partially automated vehicle driving, and a controller that controls the driving support in accordance with a determination result by the determiner.

Accordingly, the vehicle-mounted interface device can appropriately control a driving support according to driver's degree of familiarity.

For example, the driving supporter may learn at least one of a driving operation of the vehicle by the driver and a change of an option of the driving support by the driver, and predict a driving operation desired by the driver, based on a result of the learning. Then, the driving supporter may execute a driving prediction so as to provide a driving support in accordance with the predicted driving operation. In this case, the controller may set a proportion (a percentage) of resources allocated to the learning with respect to resources allocated to the driving prediction to be greater in the case where the determiner determines that the driver is unfamiliar with the route along which the driver is to drive or is driving the vehicle, compared to the case where the determiner determines that the driver is familiar with the route along which the driver is to or is driving the vehicle.

Accordingly, the vehicle-mounted interface device can appropriately allocate resources to driving prediction and learning in accordance with the driver's degree of familiarity.

For example, the driving supporter may provide a predetermined driving support without executing driving prediction when the determiner determines that the driver is unfamiliar with the route along which the driver is to drive or is driving the vehicle.

Accordingly, the vehicle-mounted interface device can allocate more resources to the learning when the driver is unfamiliar with the route.

For example, the driving supporter may learn at least one of a driving operation of the vehicle by the driver and a change of an option of the driving support by the driver, and provide the driving support based on a result of the learning. In this case, the controller may causes the driving supporter to use different learning databases depending on whether the determiner determines that the driver is unfamiliar with the route along which the driver is to drive or is driving the vehicle or determines that the driver is familiar with the route along which the driver is to drive or is driving the vehicle.

Accordingly, the vehicle-mounted interface device can provide appropriate driving support in accordance with driver's degree of familiarity by using different learning databases in accordance with the driver's degree of familiarity.

For example, the vehicle-mounted interface device may further include a display for displaying a determination result by the determiner. The determination result indicates whether or not the driver is familiar with the route along which the driver is to drive or is driving the vehicle.

Accordingly, the vehicle-mounted interface device can notify the driver of the driver's degree of familiarity.

A determination method in an aspect of the present disclosure is executed in a vehicle-mounted interface device. This determination method includes a receiving step and a determining step. In the receiving step, an input from a driver who drives a vehicle is received. In the determining step, based on the input received in the input step, whether or not the driver is familiar with a route along which the driver is to drive or is driving the vehicle is determined.

This determination method can appropriately determine whether or not the driver is familiar with the route along which the driver is to drive or is driving the vehicle on the basis of the input received by the receiver.

A program in an aspect of the present disclosure executes the above determination method by a computer.

Comprehensive or specific aspects may be achieved by a system, method, integrated circuit, computer program, or non-transitory recording medium, such as a computer readable CD-ROM. In addition, the system, method, integrated circuit, computer program, and recording medium may be combined as required.

Various exemplary embodiments are described below with reference to drawings. The exemplary embodiments described below are specific examples of the present disclosure. Accordingly, values, shapes, materials, components, positions and connections of components, steps, step sequence, and so on are examples, and are not intended to restrict the intention of the present disclosure. A component not indicated in an independent claim that is the top concept in the following exemplary embodiments is described as an arbitrary component. Same reference marks are given to same components in the exemplary embodiments to omit duplicate detailed description.

### First Exemplary Embodiment

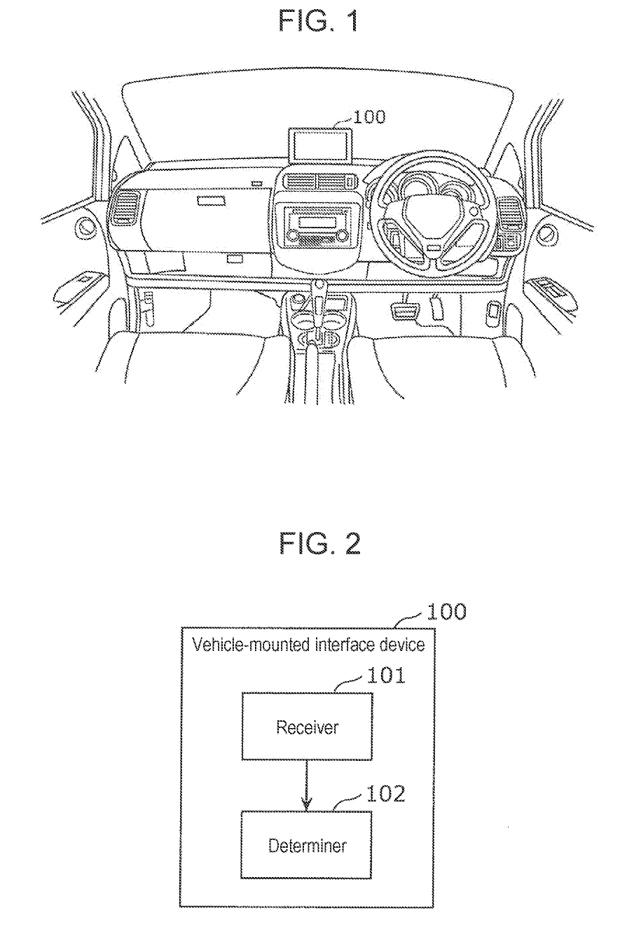

FIG. 1 illustrates an example of the use of vehicle-mounted interface device 100 according to a first exemplary embodiment. First, a configuration of vehicle-mounted interface device 100 is described. Vehicle-mounted interface device 100 is a vehicle-mounted HMI (human machine interface) device. For example, it is a car navigation device installed in a vehicle (car).

Vehicle-mounted interface device 100 determines whether or not a driver is familiar with a route along which the driver is to drive or is driving a vehicle, in accordance with an input to a receiver by the driver. More specifically, vehicle-mounted interface device 100 determines that the driver is unfamiliar with the route along which the driver is to drive the vehicle when a destination is set (input).

All or part of functions of vehicle-mounted interface device 100 described below may be achieved by other device in the vehicle connected to the car navigation device, or achieved by a device outside the vehicle connected via a network, etc.

FIG. 2 is a block diagram of vehicle-mounted interface device 100. Vehicle-mounted interface device 100 includes receiver 101 and determiner 102.

Receiver 101 includes, for example, a touch panel, and receives an input from the driver driving the vehicle. On the basis of the input received by receiver 101, determiner 102 determines whether or not the driver is familiar with the route along which the driver is to drive or is driving the vehicle. Receiver 101 is not limited to include the touch panel. It can include any input interface. For example, receiver 101 may include a voice input interface.

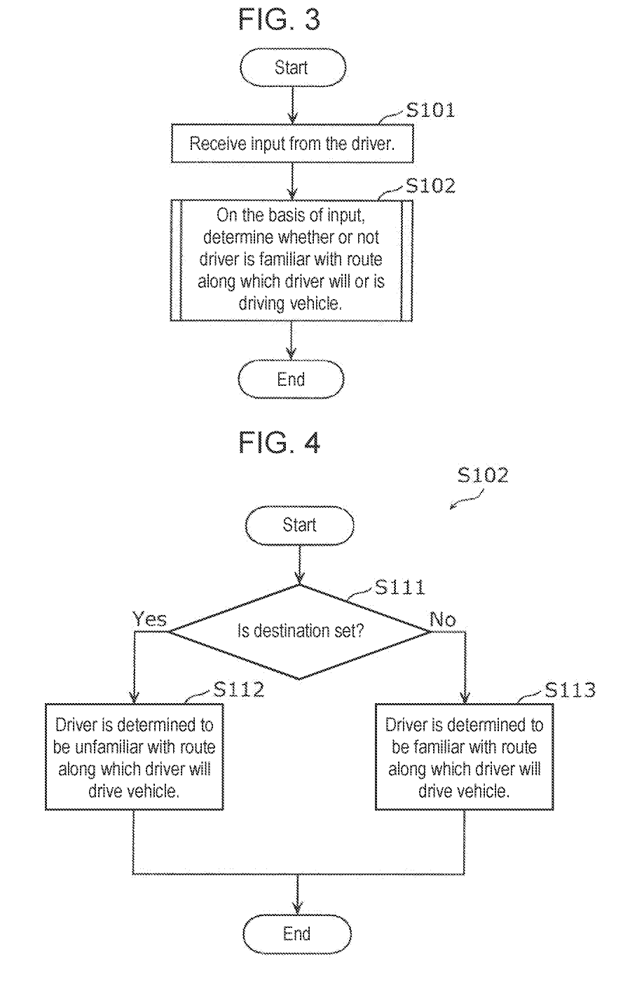

Next, the operation of vehicle-mounted interface device 100 is described. FIG. 3 is a flow chart roughly illustrating an operation of vehicle-mounted interface device 100. First, receiver 101 receives an input by the driver before or during driving (S101). Then, determiner 102 determines whether or not the driver is familiar with a route along which the driver is to drive or is driving the vehicle on the basis of the input received by receiver 101 (S102).

An example of specific operation of determiner 102 is described below. FIG. 4 is a flow chart illustrating an example of an operation by determiner 102. The following operation is executed in automated driving level 1 or 2. The automated driving level consists of Levels 1 to 4, and higher the level is, more items are automatically controlled by an automated driving system and less items are operated by the driver. The operation shown in FIG. 4 is for determining whether or not the driver is familiar with a route along which the driver is to drive the vehicle hereafter. The following operation may also be applied to automated driving level 0 (no automated driving).

First, determiner 102 determines whether or not the driver has set (input) a destination to receiver 101 (S111). The destination is a goal set to a car navigation device for route guidance.

When the destination is set (Yes in S111), determiner 102 determines that the driver is unfamiliar with the route along which the driver is to drive the vehicle (S112). On the other hand, when the destination is not set (No in S111), determiner 102 determines that the driver is familiar with the route along which the driver is to drive the vehicle (S113).

In general, the driver sets the destination typically to the car navigation device, and the car navigation device provides a route guidance in the case where the driver is not fully aware of a route to the destination, such as a first place to visit. On the other hand, in the case where the driver already knows the route well, the driver often does not set the destination (no route guidance). Accordingly, appropriate decision can be made by determining that the driver is unfamiliar with the route along which the driver is to drive the vehicle in the case where the destination is set.

### Second Exemplary Embodiment

The present exemplary embodiment refers to another example of the determination method by determiner 102.

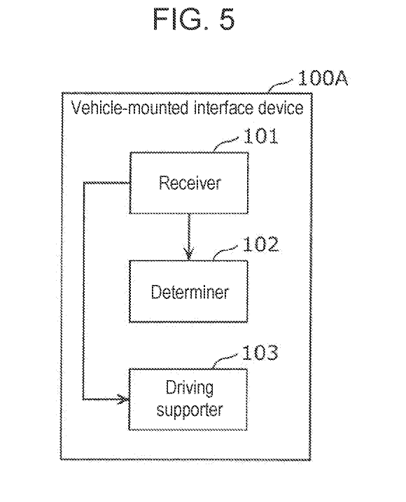

FIG. 5 is a block diagram of vehicle-mounted interface device 100A according to the present exemplary embodiment. Vehicle-mounted interface device 100A further includes driving supporter 103, compared to vehicle-mounted interface device 100 shown in FIG. 2. Driving supporter 103 provides a driving support for at least partially automated vehicle driving. For example, this driving support is equivalent to one of the aforementioned automated driving levels 1 to 4. Driving supporter 103 is detailed on and after the fourth exemplary embodiment.

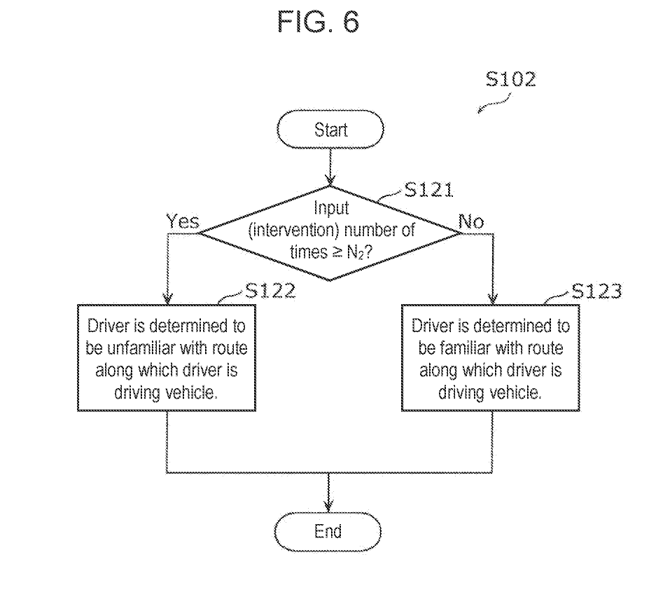

FIG. 6 is a flow chart illustrating an example of an operation by determiner 102 according to the present exemplary embodiment. The following operation is executed when the automated driving level is Level 3 or 4 and the destination is always set. The operation shown in FIG. 6 is for determining whether or not the driver is familiar with a route along which the driver is driving the vehicle.

First, determiner 102 determines whether or not a number of times of input to receiver 101 (intervention number of times) by the driver while driving is equal to or greater than predetermined threshold N₂ (S121). More specifically, the input number of times is the number of inputs (intervention) to receiver 101 by the driver while driving in order to change driving support options.

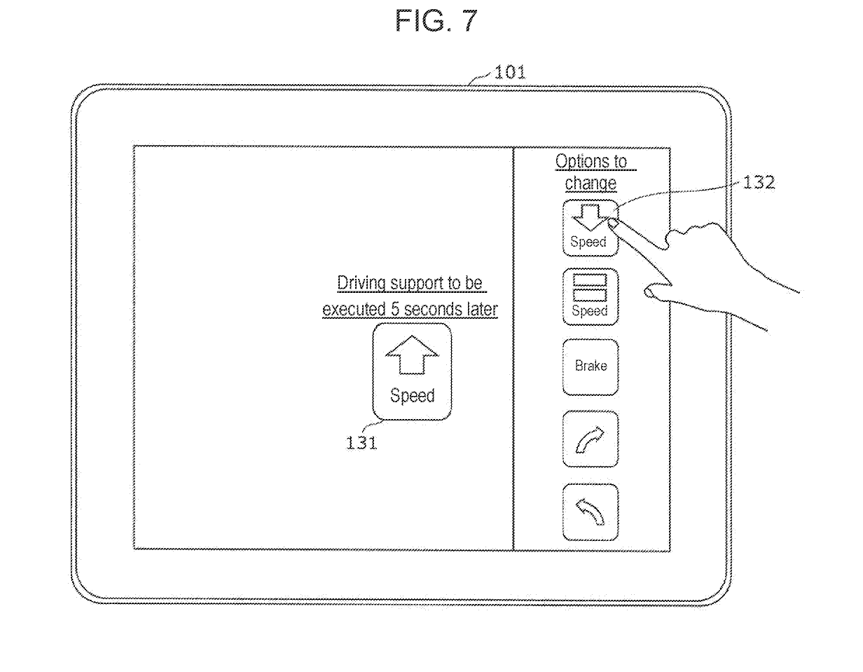

For example, as show in FIG. 7, operation content 131 executed as a driving support and menu 132 for changing driving support options are displayed on a touch panel included in receiver 101. The driver selects one of menu 132 to change a driving support option when the driver is not satisfied with the driving support to be provided. This enables the driver to control automated driving in accordance with driver's preference.

For example, in the example shown in FIG. 7, the touch panel indicates that a vehicle speed will increase five seconds later. When the driver is not satisfied with the setting, the driver selects from menu 132 to decrease the speed or keep a constant speed. As shown in FIG. 7, the driving support options and their changes are, for example, increasing and decreasing speed, keeping a constant speed, braking, and changing a lane.

Driving supporter 103 learns changes in driving support made by the driver to provide a subsequent driving support based on learning results.

When the input number of times (intervention number of times) is equal to or greater than threshold N₂ (Yes in S121), determiner 102 determines that the driver is unfamiliar with the route along which the driver is driving the vehicle (S122). On the other hand, when the input number of times is less than threshold N₂ (No in S121), determiner 102 determines that the driver is familiar with the route along which the driver is driving the vehicle (S123).

When the driver is familiar with the current route, i.e., the driver has already traveled along the route several times, there is a high possibility that driving support incorporating driver's preference is provided on the basis of the above learning process. The driver thus unlikely changes the driving support option. Accordingly, appropriate decision can be made by determining that the driver is familiar with the current route when the input number of times (intervention number of times) is small (less than threshold N₂).

In the above, an example that the input number of times is a number of times of intervention by the driver is described. However, the input number of times is not limited to the intervention number of times as long as the input number of times is the number of times the driver has input to receiver 101. For example, the input number of times may be the number of any operation during route guidance by the car navigation device, such as magnifying or reducing the size of map information and searching surrounding facilities.

### Third Exemplary Embodiment

The present exemplary embodiment describes still another example of the determination method by determiner 102.

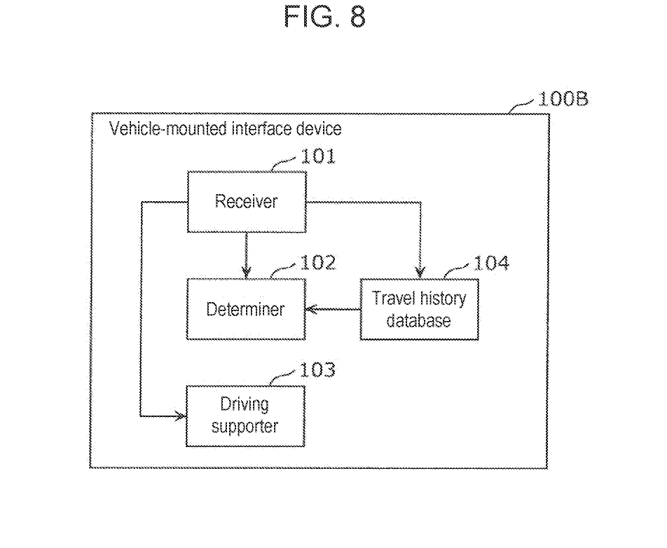

FIG. 8 is a block diagram of vehicle-mounted interface device 100B according to the present exemplary embodiment. Vehicle-mounted interface device 100B further includes travel history database 104, compared to vehicle-mounted interface device 100A shown in FIG. 5. Travel history database 104 stores a travel history. The travel history is, for example, destinations set in the past or destinations registered to a favorite list.

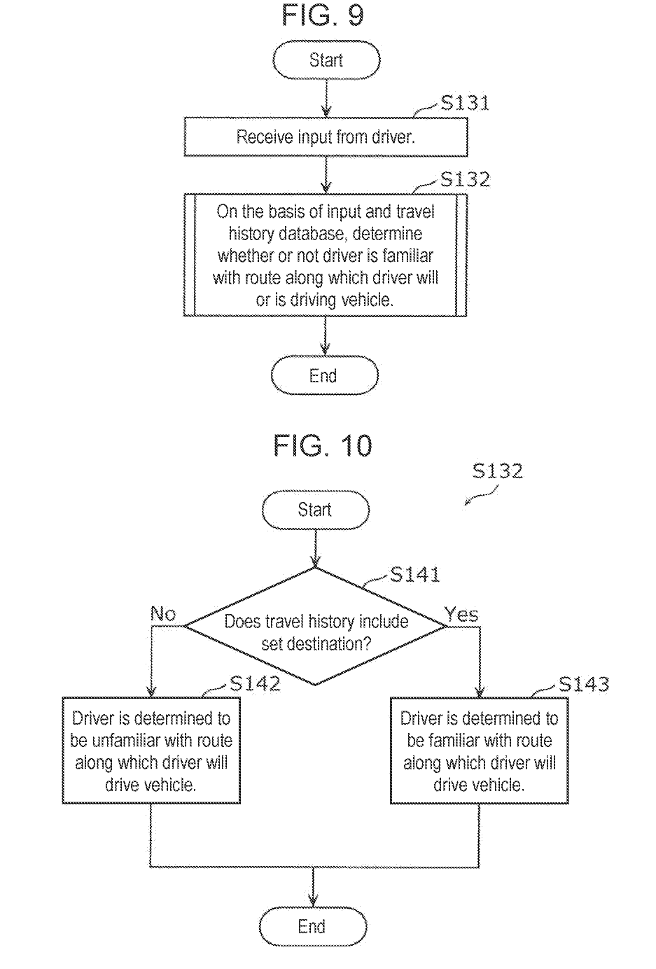

FIG. 9 is a flow chart roughly illustrating an operation of vehicle-mounted interface device 100B. First, receiver 101 receives an input from the driver before driving or while driving (S131). Then, on the basis of the input received by receiver 101 and the travel history stored in travel history database 104, determiner 102 determines whether or not the driver is familiar with a route along which the driver is to drive or is driving the vehicle (S132).

A specific example of the operation by determiner 102 is described below. FIG. 10 is a flow chart illustrating an example of an operation by determiner 102. The following operation is executed, for example, when the automated driving level is Level 3 or 4 and the destination is always set. The operation shown in FIG. 10 is for determining whether or not the driver is familiar with a route along which the driver is to drive the vehicle.

First, determiner 102 determines whether or not the driver has set a destination to receiver 101 and the set destination is included in the travel history (S141). The destination is typically a destination for automated driving.

In the case where the destination is not included in the travel history (No in S141), determiner 102 determines that the driver is unfamiliar with the route along which the driver is to drive the vehicle (S142). On the other hand, in the case where the destination is included in the travel history (Yes in S141), determiner 102 determines that the driver is familiar with the route along which the driver is to drive the vehicle (S143).

In this way, the use of travel history enables to determine whether or not the driver has driven the vehicle in the past along the route along which the driver is to drive the vehicle. Accordingly, appropriate decision can be made.

Alternatively, determiner 102 may determine on the basis of whether or not the travel number of times is equal to or greater than a threshold, instead of whether or not the destination is included in the travel history. FIG. 11 is a flow chart illustrating an example of operation of determiner 102 in this case.

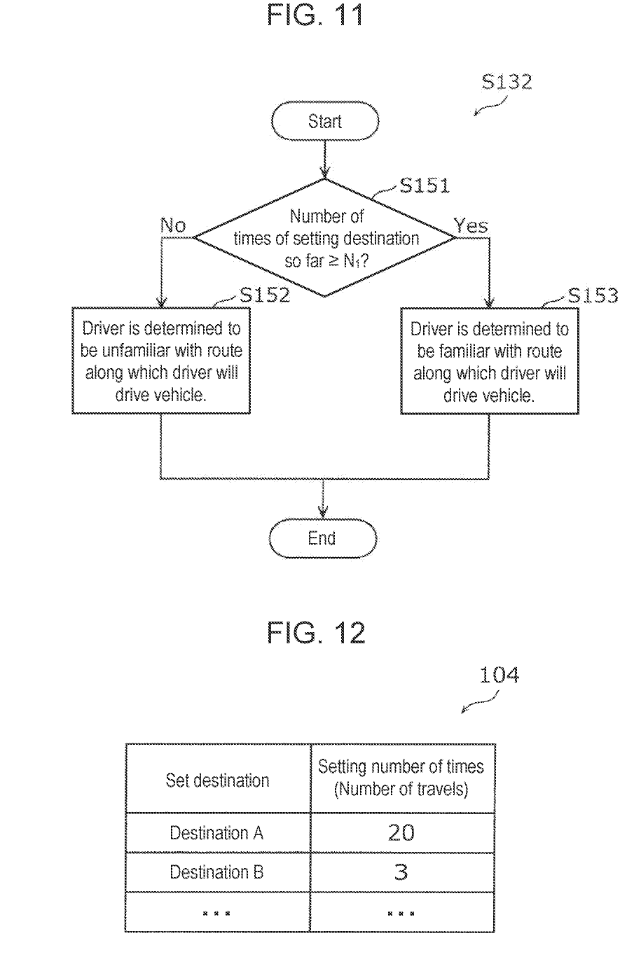

First, determiner 102 determines whether or not the driver sets a destination to receiver 101, the set destination is included in the travel history, and the travel number of times of the destination is equal to or greater than predetermined threshold N₁ (S151). FIG. 12 is an example of travel history stored in travel history database 104 in this case. As shown in FIG. 12, the travel history includes the travel number of times, which is the number of times each destination is set.

When the travel number of times is less than threshold N₁ (No in S151), determiner 102 determines that the driver is unfamiliar with the route along which the driver is to drive the vehicle (S152). On the other hand, when the travel number of times is equal to or greater than threshold N₁ (Yes in S151), determiner 102 determines that the driver is familiar with the route along which the driver is to drive the vehicle (S153).

In this way, the use of travel number of times enables to determine whether or not the driver has driven the vehicle along the route for multiple times in the past. Accordingly, appropriate decision can be made.

### Fourth Exemplary Embodiment

The present exemplary embodiment describes a control based on driver's degree of familiarity with the route determined by one of the methods in the above first to third exemplary embodiments.

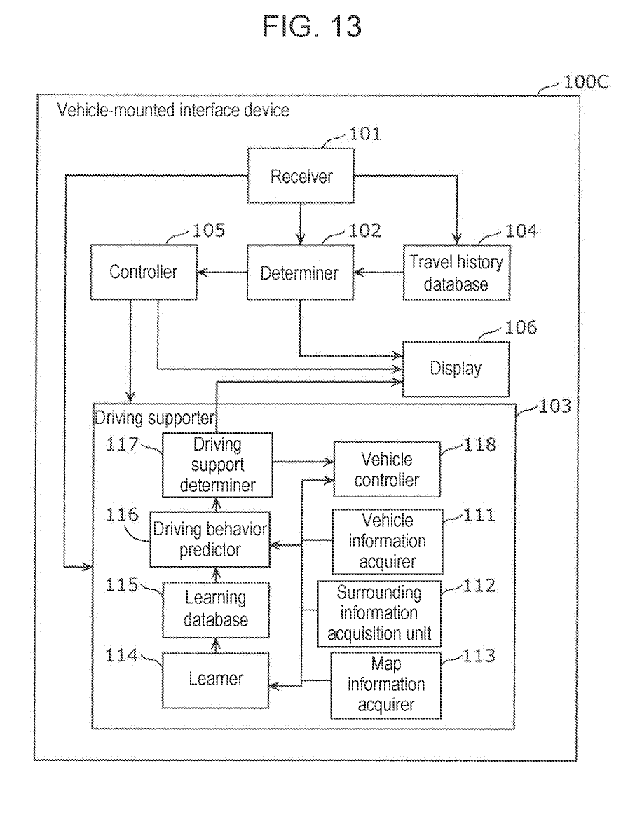

FIG. 13 is a block diagram of vehicle-mounted interface device 100C according to the present exemplary embodiment. Vehicle-mounted interface device 100C shown in FIG. 13 includes controller 105 and display 106, in addition to the configuration of vehicle-mounted interface device 100B shown in FIG. 8.

As shown in FIG. 13, driving supporter 103 includes vehicle information acquirer 111, surrounding information acquirer 112, map information acquirer 113, learner 114, learning database 115, driving behavior predictor 116, driving support determiner 117, and vehicle controller 118.

Vehicle information acquirer 111 obtains vehicle information that is information on driving operation of the vehicle to which interface device 100C is mounted. The vehicle information includes, for example, at least one of current vehicle information (speed, traveling direction, etc.), a vehicle driving operation by the driver, a driving support option, and a driver's operation for changing the driving support option.

Surrounding information acquirer 112 obtains surrounding information that is information around the vehicle to which interface device 100C is mounted. The surrounding information is, for example, information on roads, obstacles, and other vehicles around the vehicle to which interface device 100C is mounted. Map information acquirer 113 obtains information on a map surrounding the position of vehicle to which interface device 100C is mounted.

Learner 114 learns at least one of the vehicle driving operation by the driver and the driver's operation for changing the driving support option in the vehicle information. More specifically, learner 114 learns the driving operation indicated by the vehicle information by linking it with the environment indicated by the surrounding information and map information, using the vehicle information, the surrounding information, and the map information. Learning database 115 stores a learning result of learner 114.

Driving behavior predictor 116 predicts a driving operation desired by the driver on the basis of what has been learned by learner 114. More specifically, driving behavior predictor 116 predicts a driver's driving behavior on the basis of the learning result stored in learning database 115, using the current vehicle information, the current surrounding information, and the map information on the current position. The current vehicle information includes speed and traveling direction, and is obtained by vehicle information acquirer 111. The current surrounding information is obtained by surrounding information acquirer 112. Map information on the current position is obtained by map information acquirer 113. Driving behavior predictor 116 predicts a driving operation that the driver desires, on the basis of driving by the driver or a driver's instruction for driving support in the past, under the same or similar circumstance to the current circumstance.

Driving support determiner 117 determines a driving support option on the basis of a prediction result of driving behavior predictor 116. Vehicle controller 118 provides a driving support for controlling the vehicle on the basis of the driving support option, the current vehicle information, the current surrounding information, and the map information on the current position. Driving support determiner 117 determines a driving support option. As described above, the current vehicle information includes speed and traveling direction, and is obtained by vehicle information acquirer 111. Surrounding information acquirer 112 obtains the current surrounding information. Map information acquirer 113 obtains the map information on the current position.

In this way, driving prediction is executed so as to provide a driving support based on the driving operation predicted by driving behavior predictor 116.

Controller 105 controls the driving support provided by driving supporter 103 in accordance with a result, determined by determiner 102, of the driver's degree of familiarity.

Display 106 displays at least one of the determination result by determiner 102, the driving support function controlled by controller 105, and the driving support option determined by driving supporter 103.

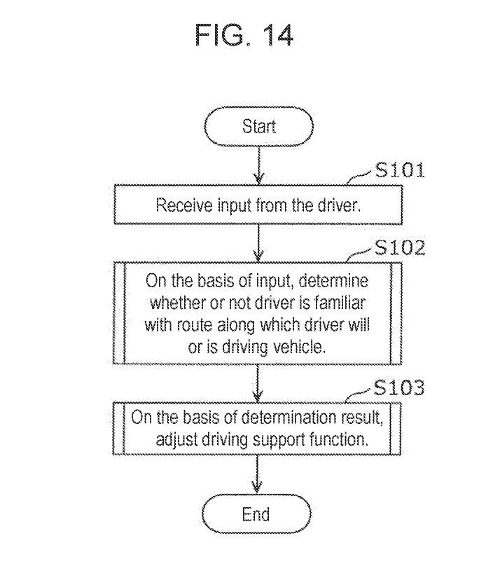

Next, the operation of vehicle-mounted interface device 100C is described. FIG. 14 is a flow chart roughly illustrating an operation of vehicle-mounted interface device 100C. The process shown in FIG. 14 includes Step S103 in addition to the steps shown in FIG. 3. An example of adding Step S103 to the process in FIG. 3 is shown here, alternatively, Step S103 may be added to the process shown in FIG. 9.

In Step S103, controller 105 adjusts a driving support function to be executed by driving supporter 103, in accordance with the determination result by determiner 102. Details are described later.

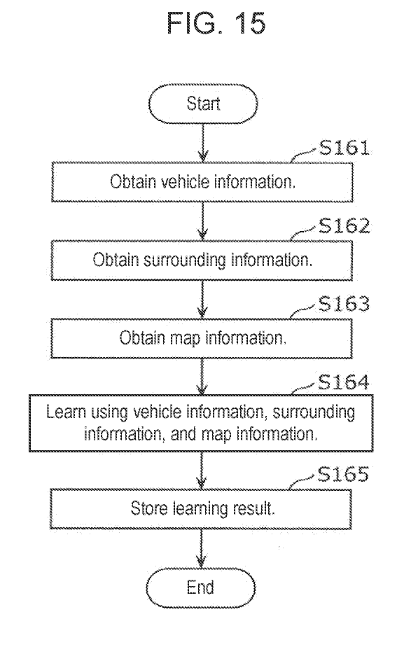

Next, a learning process by driving supporter 103 is described. FIG. 15 is a flow chart of the learning process by driving supporter 103.

First, vehicle information acquirer 111 obtains vehicle information (S161). Surrounding information acquirer 112 obtains surrounding information (S162). Map information acquirer 113 obtains map information (S163). Learner 114 learns a driving operation indicated by the vehicle information by linking it with the environment indicated by the surrounding information and map information, using the vehicle information, the surrounding information, and the map information (S164). Next, learner 114 stores a learning result into learning database 115 (S165).

Through the above steps, learner 114 learns driver's ways of driving or driver's instructions for driving support, corresponding to the environment indicated by the surrounding information and the map information The example refers to the learning process using the vehicle information, the surrounding information, and the map information. Alternatively, the learning process may take place using at least one of the vehicle information, the surrounding information, and the map information.

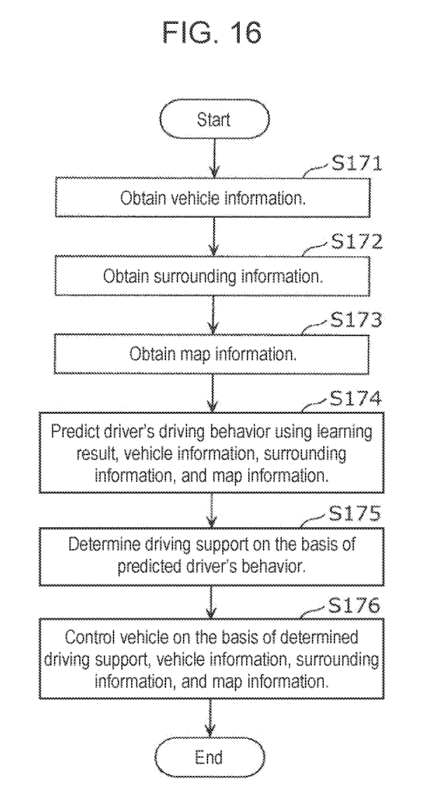

Next, the driving support process by driving supporter 103 is described. FIG. 16 is a flow chart of the driving support process by driving supporter 103.

First, vehicle information acquirer 111 obtains vehicle information (S171). For example, this vehicle information is current information on vehicle (speed, traveling direction, etc.). Surrounding information acquirer 112 obtains surrounding information (S172). Map information acquirer 113 obtains map information (S173).

Next, based on the learning result stored in learning database 115, driving behavior predictor 116 predicts a driver's driving behavior using the current vehicle information (speed, traveling direction, etc.), the current surrounding information, and the map information on the current position obtained in Steps S171 to S173 (S175).

Next, driving support determiner 117 determines a driving support option on the basis of a prediction result by driving behavior predictor 116 (S175).

Next, vehicle controller 118 provides a driving support for controlling the vehicle to which interface device 100C is mounted, based on the driving support option determined by driving support determiner 117, the current vehicle information (speed, traveling direction, etc.), the current surrounding information, and the map information on the current position obtained in Steps S171 to S173 (S176).

Through the above processes, a driving support incorporating the driver's preference is executed on the basis of the learning result. For example, in the case where the driver increased speed in the past under the circumstance similar to the current circumstance, a driving support of increasing the speed is determined. The example refers to the case of providing driving support, using the vehicle information, the surrounding information, and the map information. Alternatively, driving support may be provided using at least one of the vehicle information, the surrounding information, and the map information.

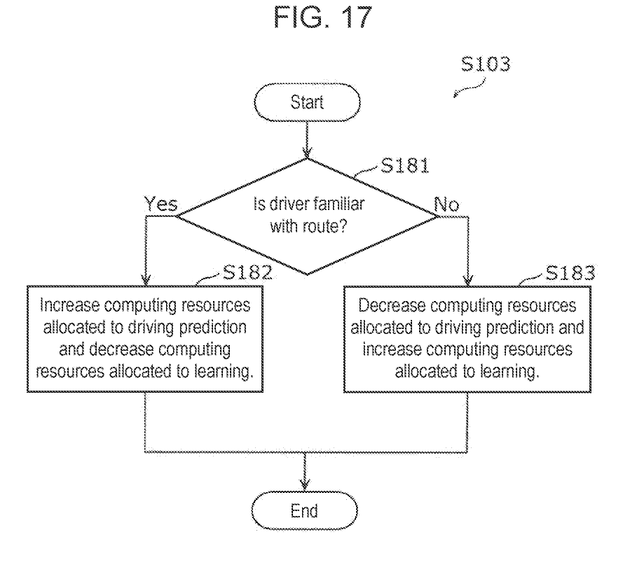

Next, a process based on a driver's degree of familiarity (S103 in FIG. 14) is detailed. FIG. 17 is a flow chart illustrating a process based on a driver's degree of familiarity.

When the driver is familiar with the route along which the driver is to drive or is driving the vehicle (Yes in S181), controller 105 increases computing resources allocated to driving prediction, and decreases computing resources allocated to learning (S182).

On the other hand, when the driver is unfamiliar with the route along which the driver is to drive or is driving the vehicle (No in S181), controller 105 decreases computing resources allocated to driving prediction and increase computing resources allocated to learning (S183).

In this way, controller 105 sets a proportion (a percentage) of resources allocated to learning with respect to resources allocated to driving prediction to be greater in the case where determiner 102 determines that the driver is unfamiliar with the route along which the driver is to drive or is driving the vehicle, compared to the case where the driver is determined to be familiar with the route along which the driver is to drive or is driving the vehicle.

When the driver is familiar with the route, there is a high possibility that condition for this route has already been learned. Accordingly, in this case, resource allocation to the learning is decreased and resource allocation to the driving prediction is increased so that a driving support based on the learning result can be provided with more accuracy. On the other hand, when the driver is unfamiliar with the route, there is a high possibility that condition for this route has not yet been learned. There is thus a high possibility that driving prediction results in low accuracy due to a high possibility that the current learning result is not appropriate. Accordingly, resources allocated to the driving prediction is decreased and resources allocated to the learning is increased in this case, so as to execute efficient learning.

In Step S182, zero computing resource may be allocated to the learning. In other words, the learning process may not be executed. In the same way, zero computing resource may be allocated to the driving prediction in Step S183. In other words, the driving prediction may not be executed.

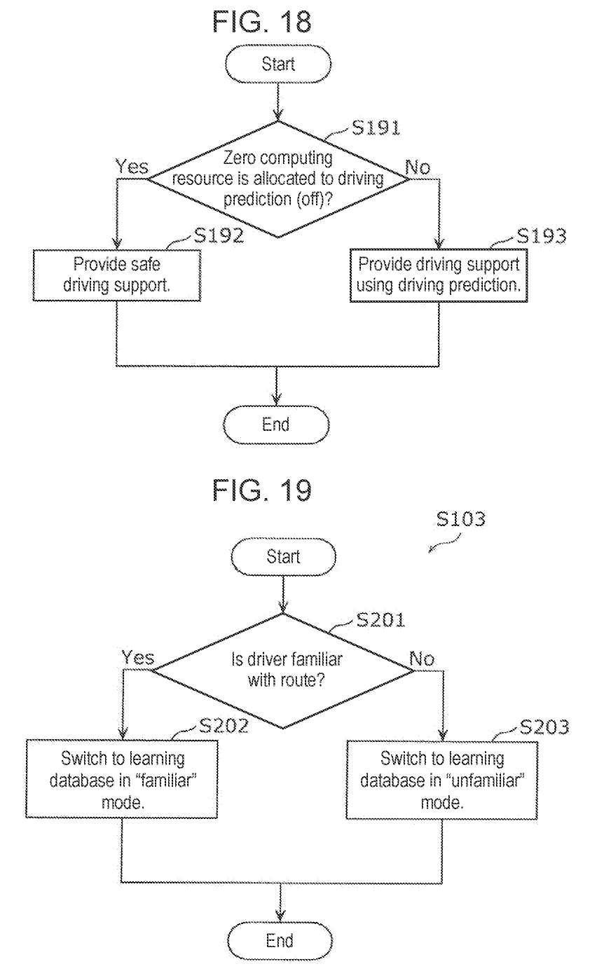

FIG. 18 is a flow chart illustrating the driving support process in accordance with computing resources allocated to the driving prediction. As shown in FIG. 18, when zero computing resource is allocated to the driving prediction (Yes in S191), driving supporter 103 does not execute driving prediction and only provides a support for safe driving (S192). The support for safe driving is a predetermined driving support (e.g., automatic brake in an emergency), and not a driving support reflecting the driver's preference based on the learning results.

On the other hand, when computing resources allocated to driving prediction is not zero (No in S191), driving supporter 103 provides a driving support incorporating the driver's preference based on the learning results, as described above (S193).

In this way, driving supporter 103 may provide a predetermined driving support without executing the driving prediction when the driver is determined to be unfamiliar with the route along which the driver is to drive or is driving the vehicle.

### Fifth Exemplary Embodiment

The present exemplary embodiment describes another control method based on the driver's degree of familiarity with a route.

FIG. 19 is a flow chart of a process based on the driver's degree of familiarity according to the present exemplary embodiment.

When the driver is familiar with the route along which the driver is to drive or is driving the vehicle (Yes in S201), controller 105 switches learning database used by driving supporter 103 for learning and driving prediction to a learning database in a “familiar” mode (S202).

On the other hand, when the driver is unfamiliar with the route along which the driver is to drive or is driving the vehicle (No in S201), controller 105 switches the learning database used by driving supporter 103 for learning and driving prediction to a learning database in an “unfamiliar” mode (S203).

In this way, controller 105 controls driving supporter 103 to use different learning databases between the case where determiner 102 determines that the driver is unfamiliar with the route along which the driver is to drive or is driving the vehicle and the case where determiner 102 determines that the driver is familiar with the route along which the driver is to drive or is driving the vehicle.

Accordingly, an appropriate driving support can be provided to both cases where the driver is familiar and unfamiliar with the route, respectively.

The vehicle-mounted interface device according to the exemplary embodiments of the present disclosure is described above, but the present disclosure is not limited to these exemplary embodiments.

Each processing part included in the vehicle-mounted interface device according to each of the above exemplary embodiments is typically achieved by an LSI, which is an integrated circuit. Each part may be configured with one chip, or some or all parts may be configured with one chip.

Still more, the circuit integration is not limited to an LSI. An exclusive circuit or a general-purpose processor is applicable. FPGA (Field Programmable Gate Array) that can be programmed after fabricating LSI or a reconfigurable processor in which connections and settings of circuit cells inside LSI can be reconfigured is also applicable.

Each component described in the above exemplary embodiments may be configured with an exclusive (or dedicated) hardware or by executing a software program suited for each component. Each component may also be achieved by reading out and executing a software program stored in a recording medium such as a hard disk and semiconductor memory, and executing the software program by a program executer such as a CPU and a processor.

Still more, division of functional blocks in the block diagrams are just an example. Multiple functional blocks may be achieved as one functional block, one functional block may be divided into multiple blocks, or some functions may be transferred to other functional block. Functions of multiple functional blocks that have similar functions may be processed in parallel or in a time-division manner by a single hardware or a single software.

A sequence of executing the steps in the flow charts is an example for specifically describing the present disclosure, and thus other sequences are also applicable. Still more, some of the above steps may be executed simultaneously (in parallel) with other step(s).

Multiple aspects of the vehicle-mounted interface device are described base on the exemplary embodiments. However, the present disclosure is not limited to these exemplary embodiments. Any modifications to the exemplary embodiments that a person skilled in the art can think of and embodiments achieved by combining components of different exemplary embodiments are embraced in the scope of one or more embodiments without departing from the scope of the present disclosure.

The present disclosure is applicable to a vehicle-mounted interface device, such as a car navigation device having an automated driving function.

What is claimed is:

1. A vehicle-mounted interface device comprising:
a receiver configured to receive an input from a driver who drives a vehicle; and
a determiner configured to determine whether or not the driver is familiar with a route along which the driver is to drive the vehicle or a route along which the driver is driving the vehicle, based on the input received by the receiver,
wherein the determiner:
determines that the driver is unfamiliar with the route along which the driver is to drive the vehicle when the driver sets a destination to the receiver; and
determines that the driver is familiar with the route along which the driver is to drive the vehicle when the driver does not set a destination to the receiver.

2. The vehicle-mounted interface device according to claim 1, further comprising a travel history database that stores a travel history,
wherein the determiner determines that the driver is unfamiliar with the route along which the driver is to drive the vehicle when the driver sets the destination to the receiver and the set destination is not included in the travel history.

3. The vehicle-mounted interface device according to claim 2,
wherein the determiner determines that the driver is familiar with the route along which the driver is to drive the vehicle when the driver sets the destination to the receiver and the set destination is included in the travel history.

4. The vehicle-mounted interface device according to claim 2,
wherein the travel history includes a travel number of times to the destination, and
the determiner:
determines that the driver is unfamiliar with the route along which the driver is to drive the vehicle when the driver sets the destination to the receiver, the set destination is included in the travel history, and the travel number of times to the destination is less than a first predetermined threshold; and
determines that the driver is familiar with the route along which the driver is to drive the vehicle when the driver sets the destination to the receiver, the set destination is included in the travel history, and the travel number of times to the destination is equal to or greater than the first predetermined threshold.

5. The vehicle-mounted interface device according to claim 1,
wherein the determiner:
determines that the driver is unfamiliar with the route along which the driver is driving the vehicle when an input number of times of input by the driver to the receiver while driving is equal to or greater than a second predetermined threshold; and
determines that the driver is familiar with the route along which the driver is driving the vehicle when the input number of times is less than the second predetermined threshold.

6. The vehicle-mounted interface device according to claim 5, further comprising a driving supporter configured to provide a driving support for at least partially automated driving of the vehicle,
wherein the input number of times is an number of inputs by the driver for changing an option of the driving support while driving.

7. The vehicle-mounted interface device according to claim 1, further comprising:
a driving supporter configured to provide a driving support for at least partially automated driving of the vehicle; and
a controller configured to control the driving support in accordance with a determination result by the determiner.

8. The vehicle-mounted interface device according to claim 7,
wherein the driving supporter:
learns at least one of a driving operation of the vehicle by the driver and a change of an option of the driving support by the driver;
predicts a driving operation desired by the driver, based on a result of the learning; and
executes a driving prediction so as to provide the driving support in accordance with the predicted driving operation, and
the controller sets a proportion of resources allocated to the learning with respect to resources allocated to the driving prediction to be greater in a case where the determiner determines that the driver is unfamiliar with the route along which the driver is to drive the vehicle or the route along which the driver is driving the vehicle, compared to a case where the determiner determines that the driver is familiar with the route along which the driver is to drive the vehicle or the route along which the driver is driving the vehicle.

9. The vehicle-mounted interface device according to claim 8,
wherein the driving supporter provides a predetermined driving support without executing the driving prediction when the determiner determines that the driver is unfamiliar with the route along which the driver is to drive the vehicle or the route along which the driver is driving the vehicle.

10. The vehicle-mounted interface device according to claim 7,
wherein the driving supporter:
learns at least one of a driving operation of the vehicle by the driver and a change of an option of the driving support by the driver; and
provides the driving support based on a result of the learning, and
the controller causes the driving supporter to use different learning databases depending on whether the determiner determines that the driver is unfamiliar with the route along which the driver is to drive the vehicle or the route along which the driver is driving the vehicle or determines that the driver is familiar with the route along which the driver is to drive the vehicle or the route along which the driver is driving the vehicle.

11. The vehicle-mounted interface device according to claim 1, further comprising a display configured to display a result being determined by the determiner and indicating whether or not the driver is familiar with the route along which the driver is to drive the vehicle or the route along which the driver is driving the vehicle.

12. A determination method in a vehicle-mounted interface device, comprising:
receiving an input from a driver who drives a vehicle; and
determining whether or not the driver is familiar with a route along which the driver is to drive the vehicle or a route along which the driver is driving the vehicle, based on the received input.

13. A non-transitory storage medium storing a program configured to make a computer execute the determination method according to claim 12.
